(19) United States
(12) Patent Application Publication
(10) Pub. No.: US 2009/0207688 A1
(43) Pub. Date: Aug. 20, 2009

(54) LID ASSEMBLY FOR REDUCING AIR PRESSURE IN A MIXING VESSEL WITHIN AN ASYMMETRICAL CENTRIFUGAL MIXING SYSTEM

(76) Inventor: Dale R. Flackett, Landrum, SC (US)

Correspondence Address: GEHRKE & ASSOCIATES, S.C., 123 N. 86th ST, WAUWATOSA, WI, 53226, US

(21) Appl. No.: 12/033,887

(22) Filed: Feb. 19, 2008

(51) Int. Cl. B01F 13/06

(52) U.S. Cl. 366/139

(57) ABSTRACT

The present invention is a system using a lid assembly with an integrated air valve that allows for the creation and maintenance of lower air pressure or vacuum within the mixing vessel. The mixing vessel can be placed in an asymmetrical centrifugal mixer and mixed while the material is under lower pressure or vacuum but while the vessel is not in contact with the vacuum pump. The vacuum or lower pressure assists in the removal of bubbles in the mixed materials. This system may be used with existing mixing vessels and placed inside existing asymmetrical centrifugal mixers.

### BACKGROUND OF THE INVENTION

1. Field of Invention

The present invention relates generally to a lid assembly for a mixing vessel that incorporates an air valve to allow the evacuation of air from the mixing vessel.

2. Discussion of Relevant Prior Art

Asymmetric centrifugal mixing systems when used to mix and de-air materials work remarkably well at higher speeds for thick and hard to de-air materials and lower speeds for lower viscosity and easier to mix materials.

In most cases, such systems de-air satisfactorily. However, in some systems or for some applications micro bubbles (normally only seen under a microscope) may still exist. There are also rare instances where the material itself (due perhaps to the surfactant package or just the nature of the polymer being mixed) prevents the air bubbles from being removed. Additionally volatiles may need to be removed. In such cases a vacuum is required to remove the micro bubbles. Also, volatiles may need to be removed.

It is possible to simply mix the material and then put the resulting mix, while still in the mixing vessel, in a vacuum chamber. While this works, it has the disadvantage that the material will rise up the mixing vessel and the vacuuming process may need to be carried out several times to remove all the micro bubbles. In addition, this method does not work satisfactorily for very thick viscous materials.

There are currently mixers in which the entire mixing chamber or entire mixer is placed under vacuum during mixing. This works well but these mixers are more costly to produce due to seals exposed to vacuum, dedicated vacuum pump and various additional controls that are required. Also, the present invention can be applied to existing machines.

### BRIEF SUMMARY OF THE INVENTION

The present invention provides a lid assembly for a mixing vessel. In particular, the present invention provides a lid assembly for a mixing vessel for mixing vessels used in asymmetric centrifugal-type mixers. The lid assembly has an integrated air valve. The valve allows a vacuum pump to be temporarily connected to the covered mixing vessel. The pump removes air from the covered mixing vessel. The pump can then be disconnected, the integrated air valve either closes automatically or manually to prevent air from reentering the covered mixing vessel. The mixing vessel may then be placed in the mixer and mixed.

The vacuum or reduced pressure inside the mixing vessel encourages air bubbles in the material being mixed during mixing to migrate out of the mixed material and into the vacuum. Once mixed, the vacuum is removed either by manually allowing air to return to the mixing vessel via the valve opening, or overtime through the seals. The level of vacuum anticipated for use by this system can very from low to extremely high as required and depending on the efficiency of the vacuum pump.

### BRIEF DESCRIPTION OF THE DRAWINGS

FIG. 1 is a top down view of the semi-flexible embodiment of the lid assembly.

FIG. 2 is a side view of the semi-flexible embodiment of the lid assembly, as it would be placed on a mixing vessel.

FIG. 3 is a top down view of the rigid embodiment of the lid assembly.

FIG. 4 is a side view of the rigid embodiment of the lid assembly, as it would be placed on a mixing vessel.

FIG. 5 is a side view showing how a vacuum pump would be connected to the lid assembly using a coupling connection fitting connected to an air valve.

FIG. 6 is a side view showing how a vacuum pump would be connected to the lid assembly using a needle that is pushed through an air valve.

### DETAILED DESCRIPTION OF THE INVENTION

The following description of preferred embodiments is merely exemplary in nature and is in no way intended to limit the invention, its application or uses.

The lid assembly is easily adapted to existing and future mixing vessels used in an asymmetrical centrifugal mixing system. The lid assembly allows the air in a mixing vessel to be evacuated. This creates a reduced pressure or vacuum within the mixing vessel.

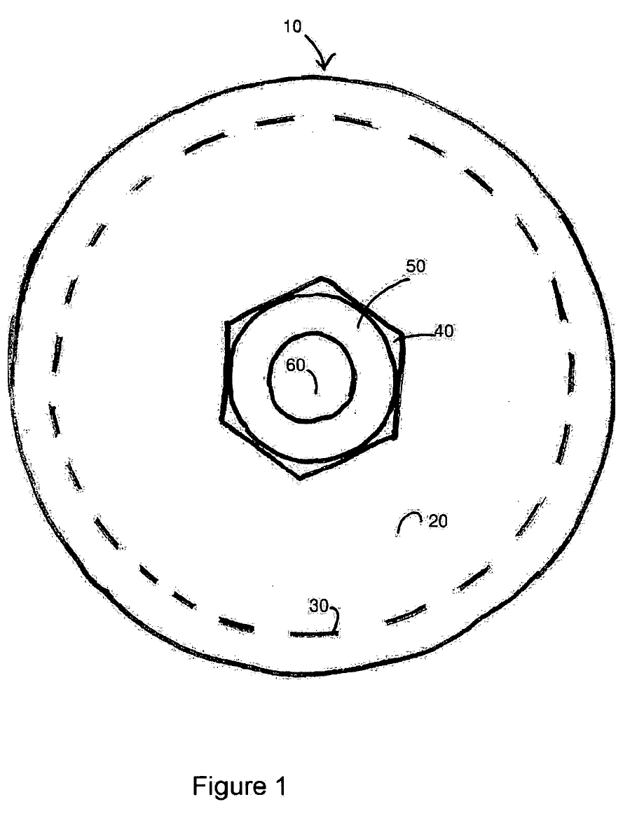

Referring now to FIG. 1, one embodiment of the lid assembly (10) is comprised of a lid (20), an interior nut or affixing item (40), an exterior valve (50), and an air flow opening (60) in the valve. An aperture exists in the lid (20). An interior nut or affixing item (40) secures an exterior valve (50) within the aperture. The interior nut or affixing item (40) and the exterior valve (50) together are the valve assembly (70). The valve assembly (70) has an airflow opening (60) through which air may be evacuated.

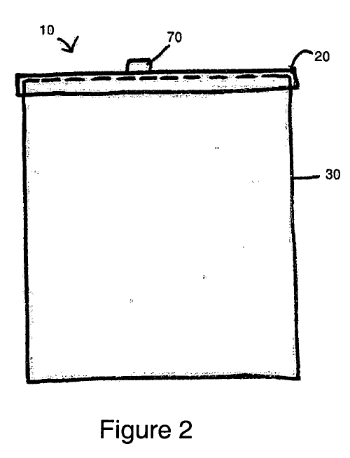

In order to create a vacuum, the lid assembly (10) is placed on top of the mixing vessel (30) as shown in FIG. 2. In this case, the lid (20) is made of a flexible or semi-flexible material. The lid must create an airtight seal. The material should have enough flexibility and softness that, when a vacuum is applied via the valve assembly (70), the lid (20) flexes downward over the outside edge of the mixing vessel (30) and then forms an airtight seal with the mixing vessel (30). Here the mixing vessel can be a flexible cup or cartridge or syringe. The maximum size being governed by the strength of the container to avoid deforming and thus lose vacuum integrity.

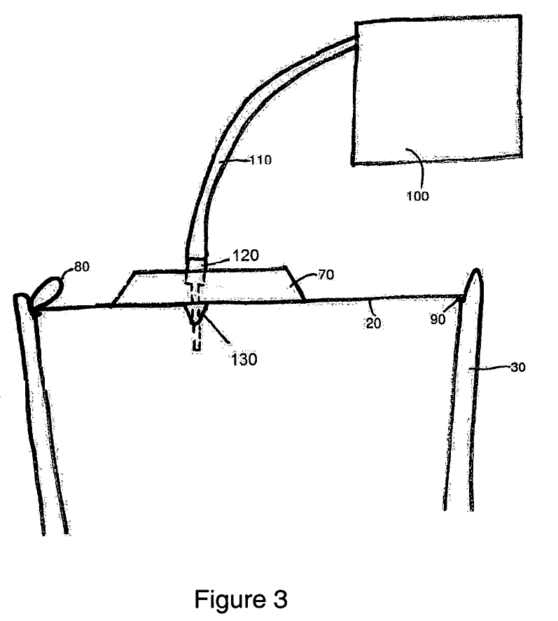

Now referring to FIG. 3, an alternative embodiment uses an evacuating needle (120). The evacuating needle (120) is pushed through a flexible one-way air valve (130). The hollow interior of the evacuating needle (120) allows the air to move through the evacuating needle (120) and vacuum tubing (110) to the vacuum pump (100). Once enough air has been evacuated, the evacuating needle (120) is removed and the flexible one-way air valve (130) reseals preventing air from returning.

In the following cases the container and lid are rigid and most likely to house cups, cartridges and syringes of various sizes. These are accommodated either directly into the chamber or by using various holders or inserts inside the chamber. This has the advantage that larger cups, cartridges and syringes can be used without risk of deforming and higher vacuums can be used. They have the disadvantage of being heavier and more expensive. Also various holders (inserts) can be used to allow a range of container sizes to be used.

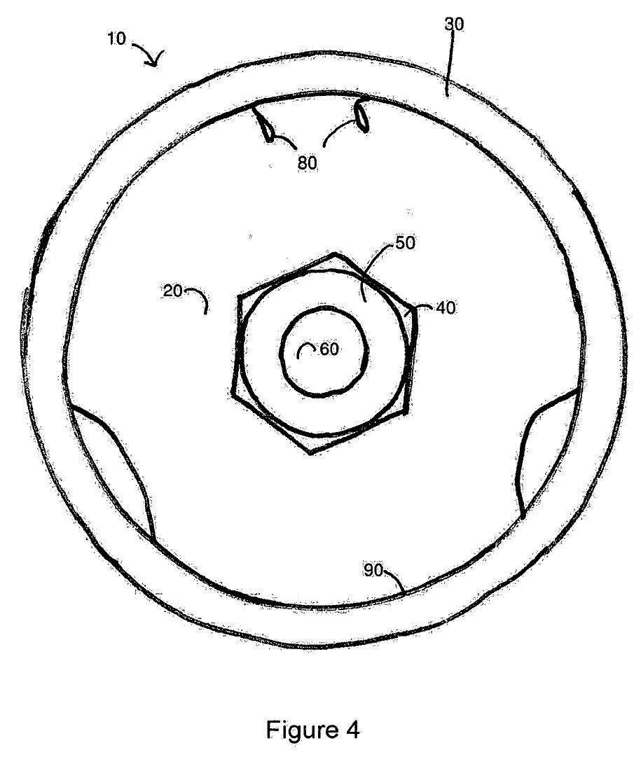

Referring now to FIG. 4, in an alternative embodiment, the lid assembly (10) is comprised of a lid (20), an interior nut or affixing item (40), an exterior valve (50), an air flow opening (60) in the valve, a lid retention system (sometimes wire)—this is purely for safety in case the vacuum is lost during mixing and the lid may want to come off (80) and an O-ring or gasket (90). A hole exists in the lid (20). In the space created by this hole, an interior nut or affixing item (40) secures an exterior valve (50). The interior nut or affixing item (40) and the exterior valve (50) together are the valve assembly (70). The valve assembly has an airflow opening (60) through which air may be evacuated. In this case the mixing vessel is

In this embodiment, the lid (20) sits on an O-ring or gasket (90), which in turn rests upon a ridge formed toward the top of the mixing vessel (30). The lid in this case is made of a rigid material. A wire lid retention system (80) is used to keep the lid (20) in place. The O-ring or gasket (90) allows the rigid material be pulled downward when the vacuum is applied and creates an airtight seal.

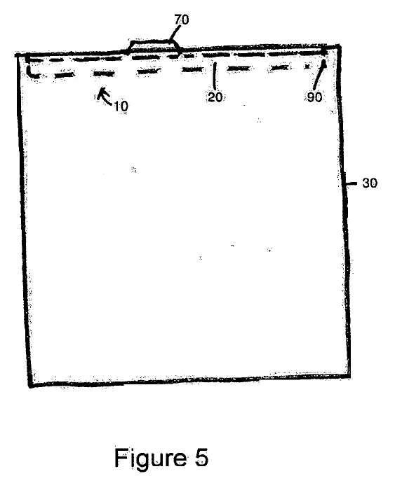

FIG. 5 shows a side view of how the lid (20) sits on top of the mixing vessel (30).

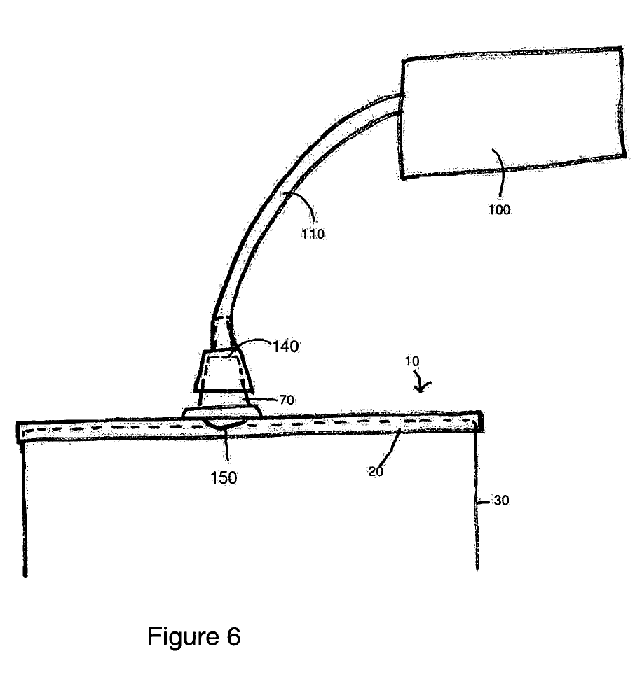

Referring now to FIG. 6, a vacuum is created by first placing the lid assembly (10) on top of the mixing vessel (30). A vacuum pump (100) with vacuum tubing (110) and a connection fitting (140) is attached to the valve assembly (70). If the air valve (150) is manually operated, it is opened so that air can flow out from the mixing vessel (30) to the vacuum pump (100). If the air valve (150) is automatic, this step is unneeded. The vacuum pump is activated and air flows out of the mixing vessel (30). The reduced air pressure creates an airtight seal between the lid assembly (10) and the mixing vessel (30) by drawing the lid assembly (10) downward and allowing the lid (20) to form a seal either directly with the mixing vessel (30) or with the O-ring or gasket (not shown).

With the lid assembly (10) in airtight union with the mixing vessel (30), the level of vacuum may be increased to the desired level. After the level of air pressure is lowered sufficiently, the air valve (150) is closed. If the air valve (150) is manually operated, it is manually closed so that air cannot flow out through the valve opening. If the air valve (150) is automatic, this step is unneeded. A vacuum pump (100) with vacuum tubing (110) and a connection fitting (120) are then removed from the valve assembly (70). The lid assembly (10) and the mixing vessel (30) may then be placed in a mixer for mixing.

Once the mixing is complete, the lid assembly (10) may be removed from the mixing vessel (30) by relieving the vacuum. This may be accomplished by opening the interior air valve opening (150) if it is manual.

I/We claim:

1. A system for use in an asymmetrical mixer using a lid assembly to allow the creation of a vacuum or reduced atmosphere condition in a flexible plastic mixing vessel, comprising:
an air valve,
a lid wherein a hole permanently receives the air valve, and,
a seal in the lid.

2. A system for use in an asymmetrical mixer using a lid assembly to allow the creation of a vacuum or reduced atmosphere condition in a flexible mixing vessel, comprising:
an air valve,
a lid wherein a hole permanently receives the air valve, and,
a seal in the lid.

3. A system for use in an asymmetrical mixer using a lid assembly to allow the creation of a vacuum or reduced atmosphere condition in a rigid mixing vessel, comprising:
an air valve,
a rigid lid wherein a hole permanently receives the air valve, and
an O-ring or gasket to rest between the lid and the mixing vessel.

4. A system using a lid assembly to allow the creation of a vacuum or reduced atmosphere condition in a rigid mixing vessel, comprising:
an air valve,
a rigid lid wherein a hole permanently receives the air valve, and
an O-ring or gasket to rest between the lid and the mixing vessel,
and where the container is mixed in an asymmetrical mixer with the material under lower pressure or vacuum but not connected to the vacuum pump and the time
and allows the use of various holders (inserts) to handle containers of different sizes.

5. A system for use in an asymmetrical mixer using a lid assembly to allow the creation of a vacuum or reduced atmosphere condition in a mixing vessel, comprising:
an air valve, and,
a semi-flexible or flexible lid wherein a hole permanently receives the air valve.
